(19) United States
(12) Patent Application Publication
(10) Pub. No.: US 2012/0281147 A1
(43) Pub. Date: Nov. 8, 2012

(54) CONTROL SYSTEM WITH BIDIRECTIONAL SELECTION

(76) Inventors: Chih-Chun Ho, New Taipei City (TW); Chih-Yuan Ho, New Taipei City (TW)

(21) Appl. No.: 13/100,417

(22) Filed: May 4, 2011

(51) Int. Cl. H04N 5/268

(52) U.S. Cl. 348/705; 348/E05.057

(57) ABSTRACT

A control system with bidirectional selection includes an audio/video receiving device and an audio/video transmission device. The audio/video receiving device serves to transmit an input command to a signal processing module via a first control interface for the signal processing module to generate a control signal and transmit the control signal to a detection module. According to the received control signal, a second central processor generates a switch control signal and transmits the switch control signal to an audio/video switch. According to the switch control signal, the audio/video switch selects the audio/video signal. Accordingly, the audio/video signal can be selected at both the transmission terminal and the receiving terminal.

### FIELD OF THE INVENTION

The present invention relates to an audio/video control system, and more particularly to a control system with bidirectional selection. With the control system, in remote audio/video transmission, it is unnecessary to use two sets of transmission cables for transmission of audio/video signals and selection commands or to notice the transmission terminal to switch the audio/video signals by way of communication.

### BACKGROUND OF THE INVENTION

In a public site such as an airport, a hypermarket, a metro train and a school, a remote-end receiving device such as a screen, an electronic signboard, a projector, etc. mainly serves to receive audio/video signals transmitted from an electronic device such as a DVD player, a computer and a notebook. The electronic device is generally installed in a front-end equipment room in which many electronic devices are installed. The electronic devices respectively output different audio/video signals, which are switched by means of an audio/video switch and transmitted to the remote-end receiving device.

The front-end equipment room is connected to the remote-end receiving device mainly through a signal transmission cable for transmitting the audio/video signals. The signal transmission cable can be CAT5, CAT5e or CAT6. The audio/video signals can be transmitted from the electronic device through the signal transmission cable to the remote-end receiving device for playing the received audio/video signals.

The front-end equipment room is electrically connected with the multiple electronic devices via the audio/video switch. When it is necessary to change the audio/video signals for the remote-end receiving device, an operator of the remote-end receiving device first notices an operator in the equipment room by phone. After receiving the instruction, the operator in the equipment room then controls the audio/video switch via a control interface to switch the signals with the audio/video signals generated from another electronic device. The selected audio/video signals are then transmitted to the remote-end receiving device via the signal transmission cable. According to the above, when changing the audio/video signals for the remote-end receiving device, it is necessary to first notice an operator in the front-end equipment room by way of communication. In this case, an operator is needed to stand by in the front-end equipment room and wait for the phone call. After receiving the instruction, the operator in the equipment room needs to switch the audio/video signals via the control interface. The communication quality is subject to affection of environment so that the communication between the operator of the front-end equipment room and the operator of the remote-end receiving device is unreliable. This problem must be overcome. Moreover, a complicated process is needed for switching the audio/video signals of the remote-end receiving device. As a result, the labor cost is increased and the time for switching the audio/video signals is prolonged.

Furthermore, the front-end equipment room is responsive to a large number of remote-end receiving devices. That is, the audio/video signals generated by one single equipment room must be transmitted to a plurality of remote-end receiving devices in respective positions. In the case that numerous remote-end receiving devices need to switch the audio/video signals at the same time, the front-end equipment room can hardly real-time switch the audio/video signals of all the remote-end receiving devices. Under such circumstance, a lot of waiting time is wasted.

Moreover, in some conventional devices, multiple lines are used to respectively transmit the audio/video signals and the switch signals. Different lines correspond to more than two sets of transmission and receiving devices for respectively transmitting the audio/video signals and the switch signals. This leads to difficulty in wiring and increase of cost.

According to the aforesaid, the conventional technique has the following shortcomings:
1. More than two sets of transmission lines are needed for audio/video transmission. This leads to difficulty in wiring and increase of cost.
2. An operator is needed to stand by in the front-end equipment room and wait for the switch notice from the remote-end receiving device by way of communication. Therefore, the labor cost is increased. In addition, the communication quality is subject to affection of environment so that the communication between the front-end equipment room and the remote-end receiving device is unreliable.
3. The audio/video signals cannot be real-time switched and a lot of time is cost for waiting and wasted.
4. The audio/video signals cannot be real-time switched so that it is inconvenient to use the conventional device.

### SUMMARY OF THE INVENTION

A primary object of the present invention is to provide a control system with bidirectional selection. With the control system, the switch of the audio/video signals can be controlled at the receiving terminal.

A further object of the present invention is to provide the above control system with bidirectional selection, which can real-time and more conveniently change the audio/video signals.

A still further object of the present invention is to provide the above control system with bidirectional selection. With the control system, bidirectional control is achievable with one single signal transmission cable to lower the wiring cost.

A still further object of the present invention is to provide the above control system with bidirectional selection. With the control system, bidirectional control is achievable without communication between the front-end equipment room and the remote-end receiving device. Therefore, the cost for the labor in the front-end equipment room can be reduced and the problem caused by the unreliable communication can be eliminated.

To achieve the above and other objects, the control system with bidirectional selection of the present invention includes an audio/video receiving device and an audio/video transmission device. The audio/video receiving device and the audio/video transmission device are connected with each other via a signal transmission cable for transmitting audio/video signals.

The audio/video receiving device includes an audio/video receiver, a first central processor, a first control interface and a signal processing module. The audio/video receiver has an audio/video receiving terminal electrically connected with the signal processing module.

The audio/video transmission device includes an audio/video transmitter, a detection module, a second central processor and a second control interface. The audio/video transmitter has an audio/video transmission terminal electrically connected to the audio/video receiving terminal via the signal transmission cable. The detection module is electrically connected with the audio/video transmission terminal and the second central processor.

The first control interface serves to generate an input command and transmit the input command to the first central processor. According to the input command, the first central processor operates to generate an audio/video selection signal and transmit the audio/video selection signal to the signal processing module. According to the received audio/video selection signal, the signal processing module triggers and generates a control signal and transmits the control signal to the audio/video receiving terminal of the audio/video receiver.

Via the signal transmission cable, the control signal received by the audio/video receiving terminal is transmitted to the audio/video transmission terminal. The detection module transmits the detected control signal to the second central processor. According to the received control signal, the second central processor operates to generate a switch control signal and transmit the switch control signal to an audio/video switch for switching the audio/video signals. Alternatively, the second control interface directly generates another switch control signal and transmits the switch control signal to the second central processor to switch the audio/video signals.

Accordingly, when it is desired to change the audio/video signals played by the audio/video receiving device, the audio/video signals to be played can be selected via the second control interface or the first control interface to achieve the object of bidirectional selection of audio/video signals. With the control system of the present invention, it is unnecessary to use more than two sets of signal transmission cables and equipments for bidirectional transmission of audio/video signals. Therefore, the wiring cost is lowered. In addition, it is unnecessary to notice the transmission terminal to switch the audio/video signals by way of communication so that the trouble caused by the unreliable communication can be eliminated.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a preferred embodiment of the control system with bidirectional selection of the present invention;

FIG. 2 is a block diagram showing the application of the preferred embodiment of the control system with bidirectional selection of the present invention; and

FIG. 3 is a waveform diagram of the control signal of the present invention.

### DETAILED DESCRIPTION OF THE PREFERRED EMBODIMENTS

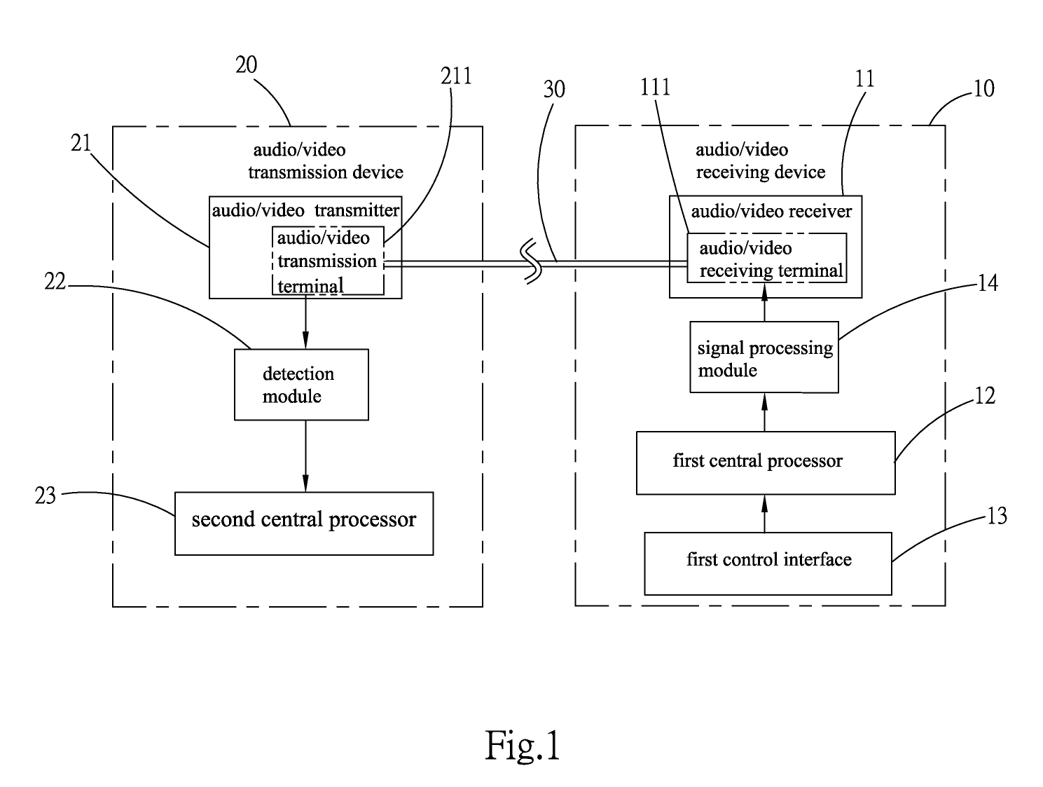

Please refer to FIG. 1, which is a block diagram of a preferred embodiment of the control system with bidirectional selection of the present invention. The control system includes an audio/video receiving device 10 and an audio/video transmission device 20. The audio/video receiving device 10 includes an audio/video receiver 11, a first central processor 12, a first control interface 13 and a signal processing module 14.

The audio/video receiver 11 has an audio/video receiving terminal 111. The audio/video receiving terminal 111 is connected to an audio/video transmission terminal 211 of the audio/video transmission device 20 via a signal transmission cable 30. The audio/video receiving terminal 111 serves to receive audio/video signals transmitted from the audio/video transmission terminal 211. That is, the audio/video transmission device 20 transmits signals to the audio/video receiving device 10 via the signal transmission cable 30 by differential transmission. In this embodiment, the signal transmission cable 30 is, but not limited to, a CAT5e cable. Alternatively, the signal transmission cable 30 can be a CAT5 cable or a CAT6 cable.

Further referring to FIG. 1, the first central processor 12 is electrically connected with the first control interface 13. According to an input command transmitted from the first control interface 13, the first central processor 12 operates to generate corresponding audio/video selection signal and then transmit the audio/video selection signal to the signal processing module 14.

The signal processing module 14 is electrically connected with the audio/video receiver 11 and the first central processor 12. According to the audio/video selection signal transmitted from the first central processor 12, the signal processing module 14 triggers and generates a control signal and transmits the control signal to the audio/video receiver 11. Via any signal line in the signal transmission cable 30, the audio/video receiver 11 transmits the control signal to the audio/video transmission device 20. According to the control signal, the audio/video transmission device 20 transmits corresponding audio/video signal to the audio/video receiving device 10.

In this embodiment, the control signal is a carry signal for illustration purposes only. In practice, the control signal alternatively can be a time signal or a packet signal.

Further referring to FIG. 1, the audio/video transmission device 20 includes an audio/video transmitter 21, a detection module 22 and a second central processor 23. The audio/video transmitter 21 has the audio/video transmission terminal 211. The audio/video transmission terminal 211 serves to transmit the received control signal to the detection module 22.

The detection module 22 is electrically connected with the audio/video transmitter 21 and the second central processor 23. The detection module 22 serves to detect the control signal transmitted from the signal processing module 14 via the signal transmission cable 30. That is, when the signal transmission cable 30 is used or not used, the detection module 22 will continuously detect the same signal line in the signal transmission cable 30 as the signal processing module 14. After the detection module 22 detects that the signal processing module 14 transmits the control signal, the detection module 22 further transmits the received control signal to the second central processor 23. According to the received control signal, the second central processor 23 operates to generate a switch control signal.

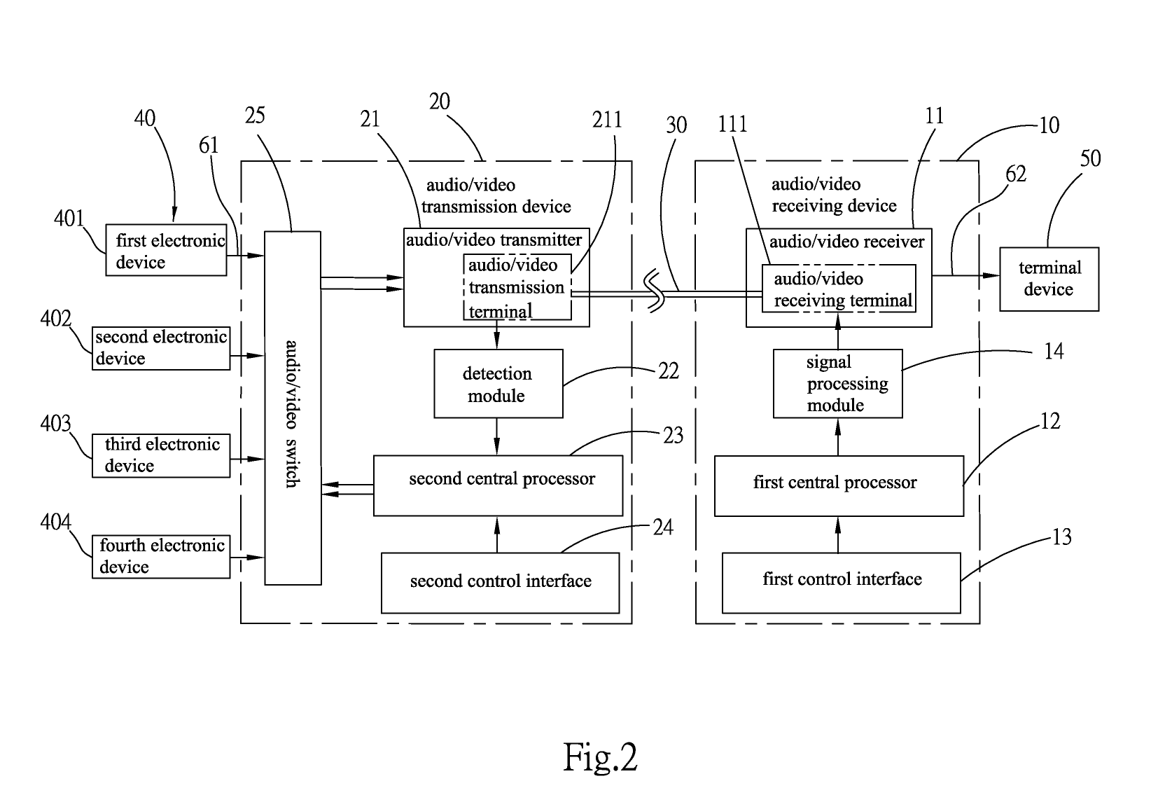

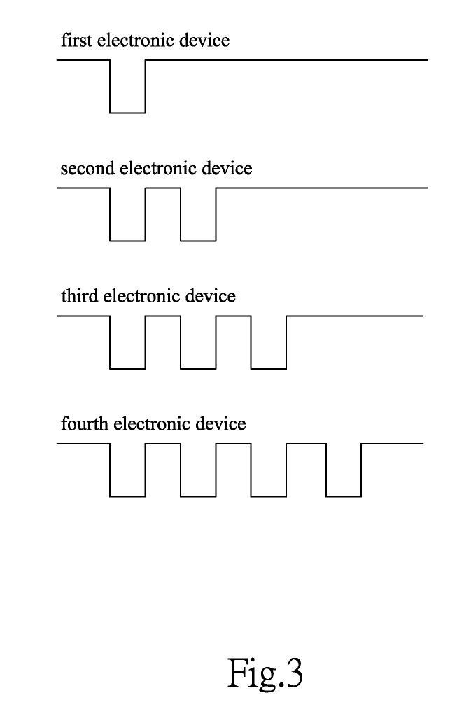

Please refer to FIG. 2, which is a block diagram showing the application of the preferred embodiment of the control system with bidirectional selection of the present invention. The audio/video transmission device 20 further includes an audio/video switch 25 electrically connected with multiple electronic devices 40 such as DVD player, computer, notebook, etc. The electronic devices 40 transmit audio/video signals to the audio/video switch 25 via multiple first signal lines 61 (such as VGA signal lines). In this embodiment, there are four electronic devices 40 for illustration purposes only. The form of each control signal corresponds to one of a first, a second, a third and a fourth electronic devices 401, 402, 403, 404 as shown in FIG. 3.

The audio/video receiving device 10 is electrically connected with at least one terminal device 50. The audio/video receiving device 10 transmits the received audio/video signal to the terminal device 50 via a second signal line 62 (such as VGA signal line) for the terminal device 50 to play. The terminal device 50 can be a screen, an electronic signboard, a projector, etc.

The following is an example for illustrating the application of the present invention:

Please refer to FIGS. 2 and 3. When the terminal device 50 plays the audio/video signal transmitted from the first electronic device 401 and a user wants to watch another electronic device such as the third one 403, the first control interface 13 transmits the input command to the first central processor 12. According to the input command, the first central processor 12 operates to generate an audio/video selection signal corresponding to the third electronic device 403. According to the received audio/video selection signal, the signal processing module 14 triggers and generates the control signal. Then, the audio/video receiver 11 transmits the received control signal to the audio/video transmitter 21 via one of the signal lines in the signal transmission cable 30. After the detection module 22 detects the control signal, the detection module 22 directly transmits the control signal to the second central processor 23. According to the received control signal, the second central processor 23 operates to generate a switch control signal corresponding to the third electronic device 403. According to the switch control signal, the audio/video switch 25 transmits the audio/video signal of the third electronic device 403 to the audio/video receiver 11 via the audio/video transmission terminal 211 and the signal transmission cable 30. The audio/video receiver 11 in turn transmits the audio/video signal to the terminal device 50, whereby the terminal device 50 is switched to play the audio/video signal of the third electronic device 403.

When it is desired to change the audio/video signal received by the audio/video receiving device 10, a second control interface 24 electrically connected with the second central processor 23 transmits another input command to the second central processor 23. The second central processor 23 processes the received input command to generate another switch control signal corresponding to the third electronic device 403 and transmit the switch control signal to the audio/video switch 25 for switching to transmit the audio/video signal of the third electronic device 403.

According to the above arrangement, by means of the control system of the present invention, it is unnecessary to use two sets of signal transmission cables for bidirectional transmission of audio/video signals or notice the transmission terminal to switch the audio/video signals by way of communication. Instead, the audio/video receiving device 10 can directly control and switch the audio/video signal. In this case, bidirectional control is achievable with one single signal transmission cable 30 to lower the wiring cost and the equipment room labor cost of the audio/video transmission device 20. Also, the trouble caused by the communication can be minimized. Accordingly, the control system of the present invention has the advantages of real-time switch between audio/video signals and convenience in use.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A control system with bidirectional selection, comprising:
an audio/video receiving device including an audio/video receiver and a first central processor, the audio/video receiver serving to receive an audio/video signal via an audio/video receiving terminal, the first central processor being electrically connected with a first control interface and a signal processing module, according to an input command transmitted from the first control interface, the first central processor operating to generate an audio/video selection signal and transmit the audio/video selection signal to the signal processing module, according to the received audio/video selection signal, the signal processing module triggering and generating a control signal and transmitting the control signal to the audio/video receiving terminal; and
an audio/video transmission device including an audio/video transmitter and a second central processor, the audio/video transmitter having an audio/video transmission terminal for transmitting the audio/video signal to the audio/video receiving terminal and receiving the control signal, the audio/video transmission terminal being electrically connected with a detection module for detecting the control signal and transmitting the control signal to the second central processor.

2. The control system with bidirectional selection as claimed in claim 1, further comprising multiple electronic devices each generates an audio/video signal.

3. The control system with bidirectional selection as claimed in claim 2, wherein the audio/video transmission device further includes an audio/video switch electrically connected with the electronic devices for switching the audio/video signals and transmitting the audio/video signals to the audio/video transmitter.

4. The control system with bidirectional selection as claimed in claim 1, wherein the audio/video receiver transmits the received audio/video signal to a terminal device.

5. The control system with bidirectional selection as claimed in claim 3, wherein, the audio/video transmission device further includes a second control interface for generating another input command, according to the other received input command, the second central processor operates to generate a switch control signal and transmit the switch control signal to the audio/video switch for switching the transmitted audio/video signals.

6. The control system with bidirectional selection as claimed in claim 1, wherein the audio/video signal and the audio/video selection signal are transmitted between the audio/video transmission terminal of the

7. The control system with bidirectional selection as claimed in claim 3, wherein according to the received control signal, the second central processor operates to generate a switch control signal and transmit the switch control signal to the audio/video switch for switching the transmitted audio/video signals.
